(19) United States
(12) Patent Application Publication
(10) Pub. No.: US 2005/0146988 A1
(43) Pub. Date: Jul. 7, 2005

(54) Nursing Monitor

(76) Inventor: Kelly M. Dolson, Howells, NY (US)

Correspondence Address: JOHN MAIER, III, 660 AARON COURT, KINGSTON, NY, 12401, US

(21) Appl. No.: 10/915,273

(22) Filed: Aug. 10, 2004

Related U.S. Application Data
(60) Provisional application No. 60/494,261, filed on Aug. 11, 2003.

(51) Int. Cl. G04B 47/00

(52) U.S. Cl. 368/10

(57) ABSTRACT

The Nursing Monitor is a device used by mothers to monitor their nursing patterns during the first six to eight weeks of breasffeeding an infant. By depressing either the right push button or the left push button depending on which breast is being utilized, the Nursing Monitor retains a record of the length of each nursing session. The respective push button is pressed at the start of the feeding and then the same button is again pressed again after the feeding has ended. A memory (NVRAM) in an electrical circuit then stores this information for up to fourteen sessions per day and for a seven day period. By depressing a menu or center push button, it is possible to select an option which will display a log of the daily feedings showing the number of feedings each day, at what time those feedings occurred and on which breast. It is also possible to review the average length of each feeding on a daily and weekly basis.

### CROSS-REFERENCE TO RELATED APPLICATIONS

This patent application claims the benefit of an earlier filing date under 35 USC 119(e) of a Provisional Patent Application, filed in the United States Patent and Trademark Office on Aug. 11, 2003, and entitled NURSING PENDANT, and being Provisional Patent Application No. 60/494,261.

### BACKGROUND OF THE INVENTION

1. Field of the Invention

The present invention relates generally to breastfeeding babies, and more particularly, to an apparatus for monitoring the progress and past history of breastfeeding sessions to allow an optimum use of a woman's breast-feeding capacity for a child's nourishment.

2. Description of the Prior Art

When breastfeeding, especially in the first two months, tracking how long the infant is nursing is a key factor to ensuring a good milk supply as well as the appropriate level of nutrition for the infant. Being able to monitor which breast the infant last nursed from is also important to maintaining the overall comfort of the mother and avoiding engorgement.

Many mothers track how long they are nursing by looking at their watches or checking a clock in the home. They track which breast was nursed from last by tying a ribbon on their right or left arm or moving a safety pin from side to side on their shirt.

The American Academy of Pediatrics recommends breast-feeding as the optimal form of nutrition for an infant in their first twelve months and each year more and more women are choosing to breast-feed. There are reams of information that support the benefits of breast-feeding. Some of the clear benefits relate to the health of the infant. Breast milk contains a unique combinations of vitamins, minerals and fats which cannot be duplicated by any supplement. This unique combination specifically promotes brain and body growth for an infant. Also several studies have been conducted which show that the nurturing touch of the mother during breast-feeding assists in the development of the infant as well as helps to promote a comforting environment for the transition from the womb.

Currently, there are no such products that exist which fill this need. There are several nursing pillows on the market that assist mothers in supporting their infants while they are nursing. None of these products contain any type of device to monitor the length of the session or which breast is being nursed on.

No device is available that is suitable for monitoring the history and time for breast feeding from a woman's two breasts. A device which monitors the history and time for breast-feeding is clearly useful and valuable.

### OBJECTS OF THE INVENTION

The objects of this invention are as follows:

1. To provide an electronic device to track and store information related to nursing sessions.

2. To help track nursing patterns of infants.

3. To reduce anxiety surrounding the need manually to track the number of nusing sessions and the length of time of each session.

4. To provide a portable, durable and easily operated device.

5. To provide a device which will retain the-nursing data even if the battery power fails.

These and other objects of the present invention will become readily apparent upon further review of the following specifications and drawings.

### SUMMARY OF THE INVENTION

The Nursing Monitor is for storing and displaying nursing patterns of breast feeding on the left breast and the right breast. The Nursing Monitor has an enclosure with a plurality of push buttons on the enclosure. There is also a display screen. An electrical circuit is connected to the plurality of push buttons and to the display screen for storing and displaying nursing patterns including the breast utilized, the time of occurrence of nursing and the time of duration of nursing.

### BRIEF DESCRIPTION OF THE DRAWINGS

FIG. 1 is a perspective view of the front panel of the Nursing Monitor showing the display and push buttons used to activate the Nursing Monitor.

FIG. 2 is a perspective view of the back panel of the Nursing Monitor showing the desk stand and the restart switch.

FIG. 3 is an exploded view from the front of the Nursing Monitor showing the components of the Nursing Monitor including the push buttons, front panel, electrical circuit, display opening, display screen and inside of the back panel.

FIG. 4 is an exploded view of the back of the Nursing Monitor also showing the separate components of the invention including the push buttons, inside of the front panel, electrical circuit, and the outside of the rear panel.

FIG. 5 is a block diagram of the electrical circuit of the Nursing Monitor.

### BRIEF DESCRIPTION OF THE NUMERALS

| NUMERAL | DESCRIPTION |
|---|---|
| 11 | Three Push Buttons |
| 13 | Right Push Button |
| 15 | Center Push Button |
| 17 | Left Push Button |
| 19 | Top |
| 21 | Front Panel |
| 23 | Display Opening |
| 24 | Display Cover |
| 25 | Pendant Holder |
| 27 | Bottom |
| 29 | Top |
| 31 | Top Section |
| 33 | Soft Rubber Covering |
| 35 | Bottom Section |
| 37 | Back Panel |
| 38 | Desk Stand |
| 39 | Assembly Screws |
| 41 | Threaded Members |
| 43 | Inside Surface |
| 45 | Outside Surface |
| 47 | Center Panel or Electrical Board |
| 49 | Display Screen |
| 51 | Battery Compartment |
| 53 | Memory-NVRAM |
| 55 | Microcontroller |
| 57 | Operational or Electrical Circuit |
| 59 | Real Time Clock |
| 61 | Input-Output Ports |
| 63 | Conditioning Circuit |
| 65 | First Interrupt Line |
| 66 | Second Interrupt Line |
| 67 | Restart Switch |
| 69 | DC/DC Converter |
| 71 | Batteries |
| 73 | Grounds |

### DETAILED DESCRIPTION OF THE PREFERRED EMBODIMENT

This Nursing Monitor assists mothers in tracking their nursing patterns. The Nursing Monitor times the nursing session and will also store the time and duration of the session as well as which breast was used for that session. The American Academy of Pediatrics recommends nursing an infant eight to twelve times a day and there is currently no electronic device to assist mothers in monitoring the number of times a day they are nursing. In addition, ensuring that each breast gets equal amounts of stimulation is important to maintaining a good milk supply and avoiding engorgement.

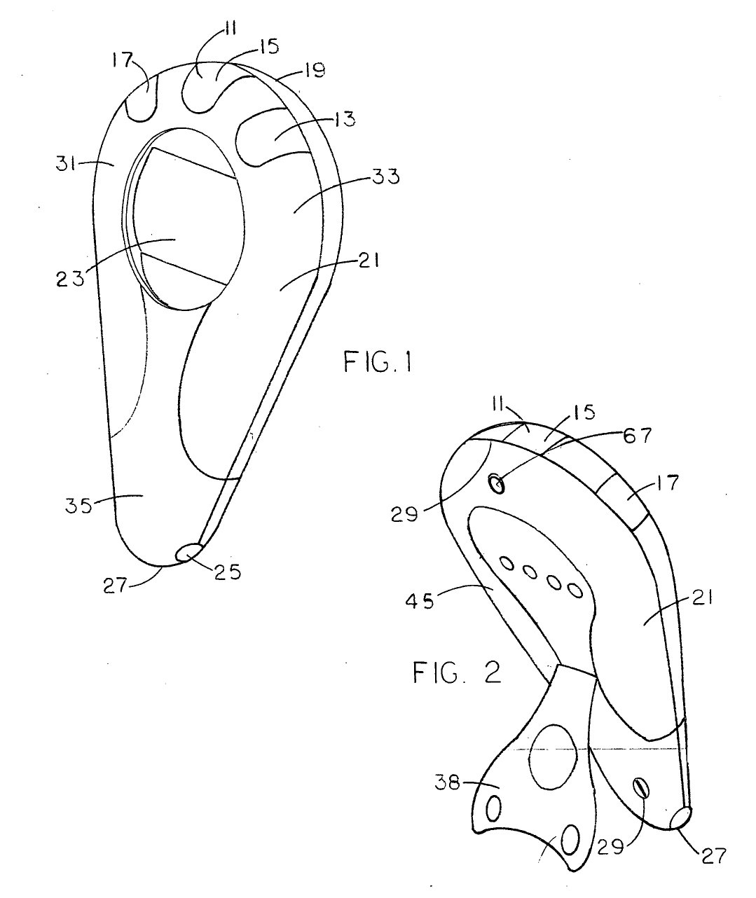

Referring to FIG. 1, the Nursing Monitor has three push buttons 11, namely a right push button 13, a center push button 15, and left push button 17. The left push button 17 is labeled and provides Left/Yes/Down. The center push button is labeled and provides Menu/Enter, 15 and the right push button 13 is labeled and provides Right/No/Yes. The three push buttons 11, are located at the top 19 of the Nursing Monitor and on a front panel 21. Directly below the three push buttons 11, there is a display opening 23. The display opening 23 is covered by a display cover 24 which is transparent. A pendant holder 25 is located at the bottom 27 of the front panel 21, where the three push buttons 11, are located on the front panel 21. A top section 31 of the front panel 21 is preferably covered by of a soft rubber covering 33, as are the three push buttons 11. A bottom section 35 of the front panel 21 is preferably plastic beneath the soft rubber covering 33.

Referring to FIG. 2, the back panel 37 of the Nursing Monitor as shown. The front panel 21 and the back panel 27are held together with assembly screws 39. The assembly screws 39 mate with threaded members 41 mounted on the inside surface 43 of the front panel 21. The three push buttons 11, are located on the front panel 21 only. A desk stand 38 is attached to the outside surface 45 of the back panel 37.

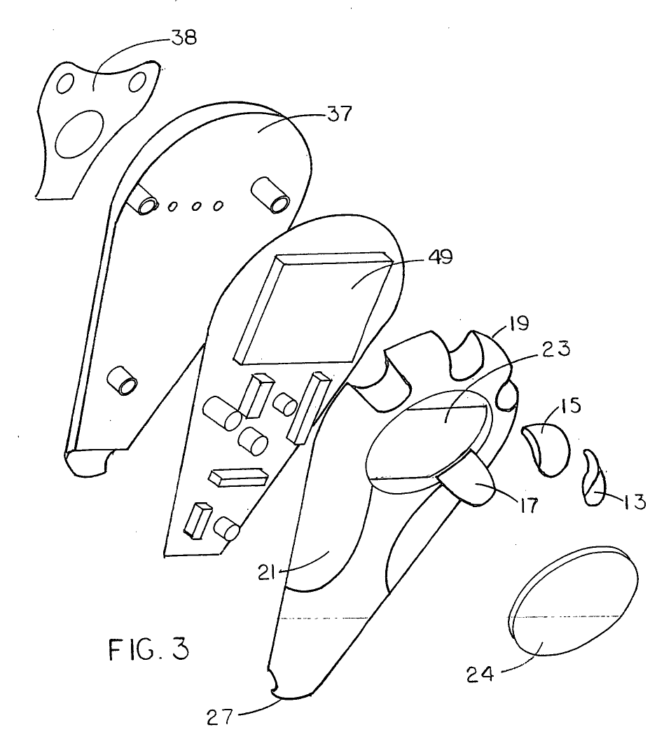

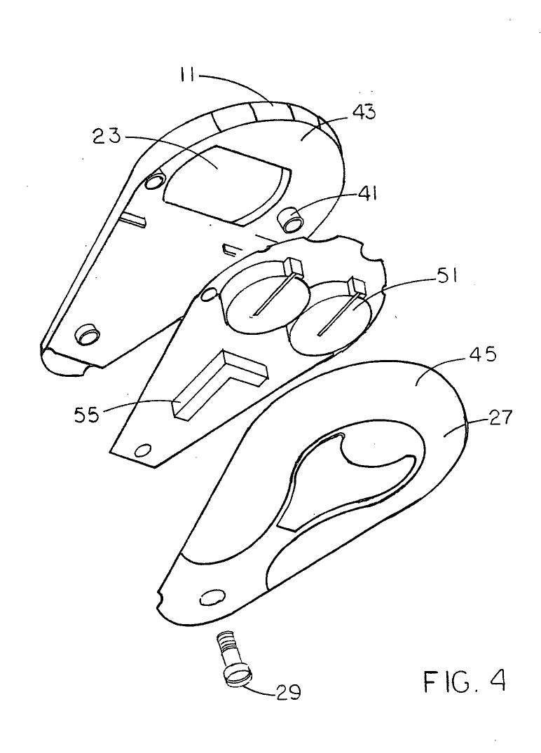

Referring now to FIG. 3, an electrical board 47, or center panel 47 is shown. The center board 47 is located between the front panel 21 and the back panel 37 and is also held in place by the assembly screws 39. The display screen 49 is located toward the top of the control panel 47 and is viewed through the display opening 23 in the front panel 21. In FIG. 4 at the rear of the center panel 47 with the battery compartments 51 and the non-volatile random access memory (NVRAM) 53 for memory storage.

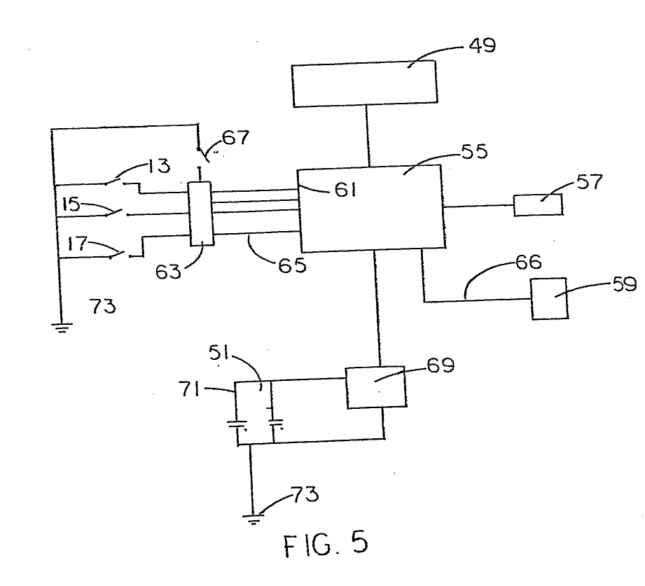

The operational circuit 57 of the Nursing Monitor is shown in FIG. 5. The Nursing Monitor is based on a microcontroller 55 which is a low power, low voltage chip within an operational circuit 57 or electrical circuit 57. A non volatile random access memory (NVRAM) 57 is connected to and is a part of the microcontroller 55. The microcontroller 55, also includes a real time clock (RTC) 59, the NVRAM 53, and interrupt structures such as the RTC 59. The operational circuit 57 also includes input/output ports 61 which supply the microcontroller 55. The microcontroller 55 includes the ability to enter a power-down mode.

Connected to the microcontroller 55 through conditioning circuits 63 are the three push buttons 11. These three push buttons 11, provide input to the Nursing Monitor and includes the right push button 13, the center push button 15 and the left push button 17. Operation of the three push buttons 13, 15, 17, is in conjunction with the display screen 49. A first interrupt line 65 from the conditioning circuits 63 generates an interrupt to the microcontroller 55 so that the push button 11, can be used to activate the microcontroller 55 from power down and to respond to the push buttons 11, on an interrupt basis. A second interrupt line 66 is located between the real time clock 59 and the microcontroller 55. A restart switch 67, located on the back panel 37 restarts the Nursing Monitor after it has been shut down.

A DC/DC converter 69 located within the operation circuit 57 transforms the voltage of batteries 71 located in the battery compartment 51 into a level useable by the operational circuit 57. This Nursing Monitor conserves power by going into a sleep mode or power down mode most of the time. During one-second interrupt pulses from the RTC, the microcontroller 55 wakes up, updates the display and then powers down. Depressing the push buttons 13, 15, 17 will also generate an interrupt wake up. As a consequence, the microcontroller 55 spends most of it's time in power-saving mode thus minimizing the power requirements. The firmware programs, which are memory programs, stored in and part of the NVRAM 53 of the microprocessor 55 are responsible for driving all the operations.

Operations

When the Nursing Monitor is activated, thereby starting the operation, the Nursing Monitor will run through an initialization process where it configures the display screen 49, checks the microcontroller 55 for previously stored data. If erroneously stored data is detected it will clear the microcontroller 55. The real time clock 59 will be set with the time and date the last time the Nursing Monitor was turned off, when the last session ran. The display area will show the following:
NURSING MONITOR
PENDANT

Then, the following message is displayed for a second:
MODEL SERIAL #100

If the initializing process for the Nursing Monitor is successful, then the display area will display for a second.
POWER ON
DIAGNOSTICS
PASSED

Thereafter, the display screen 49 shows the date and the time in the lower portion of the display screen 49. It is also possible to display the start time and duration of the last session either in the top right corner of the display screen 49 and to display the number of the session. If nothing was stored in the microcontroller 55 then there will be nothing to display on the display screen 49.

As previously stated, three push buttons 11, are labeled from left to right:
“Left/Yes/Down”, Menu Enter”, “Right/No/Up”.

When the left push button 17, is pressed the display screen 49 will show the Start time in the middle of the display screen 49 and the real time clock 59 in the microcontroller 55 will indicate the time in increments of seconds. Also the Nursing Monitor will display the message:
Feeding From Left Breast

When the left push button 17 is again pressed after at least one minute into a session, then the Nursing Monitor will store in the microcontroller 55, the session number, the start time, the duration and that the left breast was used during that session. The accumulated time of that session for the left breast for that day and the date, if it was different from the previous date will also be stored. Next, the display screen 49 will show the start time and duration at the top left corner of the display screen 49 of the just run session.

When the right push button 13 is pressed the Nursing Monitor will display the start time in the middle of the screen and in the microcontroller 55 will indicate every second. Also the Nursing Monitor will display the message:
“Feeding from Right Breast”

When you press the right push button 13 again after at least one minute into the session, then the Nursing Monitor will store in the NVRAM 53, the session number, the start time, the duration, that the right breast was used during that session and also the accumulated time of that session for that day and date, if it was different from a previous stored date. Then, the Nursing Monitor will display the start time and duration at the top right corner of the screen of the session that immediately occurred. Within a thirty second period of pressing either the left push button 17 or the right push button 13, the opposite push button can be pressed. After that, it is only necessary to press the same push button to stop the session. The push button 15 can also be pressed when running the session. The minimum time for a session is one minute and maximum is forty five minutes. After forty five minutes of starting the session, should the session not be stopped, then the microcontroller 55 will terminate the session and store forty five minutes as the duration of the session. It is possible to store fourteen sessions a day for a total of seven days. After the seventh day of operation, the program will overwrite the sessions stored on the first day and so on in a circular fashion. After the fifteenth session, the Nursing Monitor will display the following message:
REACHED LIMIT OF 14 LOGS PER DAY
DELETE LAST LOG?
PRESS ‘YES OR ‘NO’

This permits the deletion of the fourteenth session from memory in the microcontroller 55 so that the fifteenth session can be stored.

If the ‘NO’ push button is pressed, then the following message will appear at the display:
THIS SESSION
WILL NOT BE SAVED

Any key is then pressed to exit the menu. If it is desired not to delete the previous sessions after reaching the limit of fourteen, then the date should be changed using the “Set Date” menu selection with the center push button 15 before running the fifteenth session. This will mandate that the microcontroller 55 will start saving new sessions in the NVRAM 57. When the center push button 15 is pressed the display screen 49 will show a list of menu choices as follows:
DISPLAY LOG
DELETE LAST LOG
SET TIME
SET DATE
DELETE ALL LOGS
TURN UNIT OFF
EXIT MENU

To scroll through the menu selection, the left push button 17 is used to go down, or the right push button 13 is used to go up, and a selection is made by pressing the center push button 15. The selected menu will be highlighted. Exiting from the menu screen select exit menu and press the center push button 15, enter. This returns the display screen 49 to the main screen. The center push button 15 for menu can be pressed either when a session is up in operation or in-between sessions. The display log choice selection on the menu is for checking the session times and session statistics. The first line displays the session number of the day. The maximum number is fourteen. The second line shows the starting time when the breast feeding started. The third line shows the duration feeding time in minutes. The second and third lines are displayed either at the left corner or at the right corner of the display screen 49 depending on whether the left breast or the right breast was used. The fourth line shows the date of the sessions. The fifth line shows the total number of sessions for the date displayed. The sixth line shows the accumulated time for both left and right breasts for the date displayed. The display is in hours and minutes format. The seventh line shows the daily average session time in minutes. The microcontroller 55 takes the value of the accumulated time for both the left breast and the right breast for that date and divides it by the total number of sessions for that date being displayed. The eighth line shows the total average of the daily averages in minutes. It takes the value of the daily averages of session times and divides it by total number of days that a session occurred and was stored in memory.

When the display log, by pressing the center push button 15, is selected the Nursing Monitor will start with the date of the statistics of the current session. As the left push button 17 is pressed, the Nursing Monitor will scroll through the logged session times, starting with the first session of that day and until the last session up to fourteen sessions per day. After the last session of a current day, by pressing the right push button 13, the microcontroller 55 will display that statistic of the sessions which were stored for the first six days before the current day, then five days before the current day and so on until the current day providing sessions were run for that long. If there is only one day of sessions stored, then it will show on the display screen 49 only that one day. Therefore, by pressing the right push 13 button or a the left push button 17 the Nursing Monitor will return to the starting point. To exit from the menu press the center push button 15. The delete last log menu selection is for deleting the last run session from the memory of the microcontroller 55. There are various possible reasons for deleting, for example, if either the left push button 17 or the right push button 13 was pressed accidentally and the Nursing Monitor started running a session or if a session was interrupted for some time and there is no desire that such a session be stored in memory, or if a maximum limit of fourteen sessions per day has been reached and it is desired to store the most recent session. By pressing the delete last log menu selection on the menu the Nursing Monitor will delete the last session and subtract it's duration from the total accumulated time of sessions for that day. By pressing the left push button 17 when prompted by the display screen 49, the last session will be deleted. Should it be desired not to delete the last session, the right push button 13 is pressed.

The firm program in the microcontroller 55 is not programed to delete more than one session in sequence. If two sessions have occurred and one session has been deleted and it is desired to delete another session, it is necessary to run the second session again before it can be deleted. Also, after the power is turned on, if there is a last session, time displayed, it cannot be deleted. If upon returning to the previously run session it is displayed and the session number for it will be decreased by one. The set time menu selection is for editing new time. When the Nursing Monitor is again to set the real time clock 59. When set time is selected, then the time of the real time clock 59 is displayed. The real time clock 59 will continuously update the display screen 49 with a current time if the center push button is not pressed. If the center push button 15 is pressed, then the left most digit of the hour will start blinking. As for example, if the time is displayed as on, 12:45, then the “1” digit will start blinking. This digit can be increased with the right push button 13. To edit the other three time digits and “AM/PM” press the right 13 down push 13 button again and then the left button 17 to change it. To complete editing the time, press the enter push button and the time will be updated in the real time clock 59. If a new time was edited, then the display screen 49 will blink the new time three times and return to the menu. It is important to be certain that the time set on the Nursing Monitor on the display screen 49 is correct before running the sessions. After the batteries 71 have been replaced, the current time must be entered to update the real time clock 59, since it is shut down when the batteries 71 are out of the Nursing Monitor.

The set date menu selection is for editing a new date in the real time clock 59. When set date is selected, then the date of the real time clock 59 will be displayed. The first digit of the month which is usually a zero, will start blinking. This digit can be incremented with the right push button 13. To edit the other five date digits, press the left push button 17 and the updated date will be changed in the real time clock. If a new date has been edited, then the display screen 49 will blink the new date three times and then return to the menu. After the batteries 71 have been replaced the current date must be entered to update the real time clock 59, if the last stored date does not match the current date.

The delete all logs, the menu selection is for deleting all sessions and all dates from the memory of the microcontroller 55. The memory will be cleared, leaving zeroes written in every location of the NVRAM 53. It takes about two to three seconds to clear all the memory from the Nursing Monitor to the menu. To delete all sessions press the left push button 17 when so prompted.

Should it be desired not to delete all sessions, press the right push button 13. When the turn unit off selection is selected, the batteries will turn into power sleep mode. Only the real time clock 59 will remain updating the time and date. To turn the Nursing Monitor on press the restart button switch 67 on the back panel 37 of the Nursing Monitor. Also, when it is time to replace old batteries, it is recommended to use the turn unit off selection before removing batteries.

While a preferred embodiment is shown and described herein, it should be understood that the present disclosure is made by way of example only and that variations in the described Nursing Monitor and it's uses are possible within the scope of this disclosure without departing from the subject matter coming within the scope of the following claims, and a reasonable equivalency thereof, which claims I regard as my invention.

1. A Nursing Monitor for storing and displaying nursing patterns of breast feeding on the left breast and the right breast, the Nursing Monitor comprising:
an enclosure;
a plurality of push buttons on the enclosure;
an electrical circuit including a display screen connected to the plurality of push buttons for storing and displaying nursing patterns including the breast utilized the time of occurrence of nursing and the time of duration of nursing.

2. A Nursing Monitor according to claim 1 wherein the enclosure includes a front panel and a back panel the plurality of push buttons being mounted on the front panel, the front panel having an opening through it, the display screen being located in the opening in the front panel.

3. A Nursing Monitor according to claim 1 wherein the plurality of push buttons is three push buttons.

4. A Nursing Monitor according to claim 1 wherein the enclosure includes a front panel, a back panel and a center panel, the electrical current being mounted on the center panel.

5. A Nursing Monitor according to claim 1 wherein the plurality of push buttons is three push buttons a left push button, a center push button and a right push button, the left push button for indicating the left breast and yes and down, the center push button being for opening a menu and activating a enter and a right push button being for indicating the right breast and no and up.

6. A Nursing Monitor according to claim 1 wherein the electrical current is adapted to store up to fourteen sessions a day for a total of a seven day period.

7. A Nursing Monitor according to claim 1 wherein the enclosure includes a front panel and a back panel, a desk stand being mounted on the back panel.

8. A Nursing Monitor for storing and displaying nursing patterns of breast feeding on the left breast and the right breast, the Nursing Monitor comprising:
an enclosure including a front panel and a back panel and having a top and a bottom end;
three push buttons located at the top end on the front panel;
conditioning circuits, including a real time clock,
a microcontroller is connected to the conditioning circuit,
a power supply,
a DC/DC converter connected to the power supply and the microcontroller,
a non-volatile RAM connected to the microcontroller.

9. A Nursing Monitor according to claim 8 wherein the front panel has an opening in it, the display screen being located in the opening in the display screen.

10. A Nursing Monitor according to claim 8 wherein the enclosure further includes a center panel located between the front panel and the back panel, the electrical circuit being located in the center panel.

11. A Nursing Monitor according to claim 8 wherein the three push buttons a left push button include a left push button, a center push button and a right push button, the left push button being for indicating the left breast and yes and down, the center push button being for opening a menu and activating a enter and the right push button being for indicating the right breast and no and up.

12. A Nursing Monitor according to claim 8 wherein the electrical current is adapted to store up to fourteen sessions a day for a total of a seven day period.

13. A Nursing Monitor according to claim 8 including a desk stand being mounted on the back panel.

14. A Nursing Monitor according to claim 8 wherein the left push button is for left and yes and down, the center push button is for menu and is enter and the right push button is for right and no and up.

15. A Nursing Monitor for storing and displaying nursing patterns of breast feeding on the left breast and the right breast the Nursing Monitor comprising:
an enclosure having a top end and a bottom end and a front panel and a back panel and a center panel;
an electrical circuit connected to the three push buttons, the electrical circuit including:
conditioning circuits connected to the three push buttons,
a microcontroller is connected to the connecting circuits, including a non-volatile RAM for storing memory,
a display screen connected to the microcontroller:
means for supplying electrical power to the electrical circuit,
a DC/DC converter connected to the means for supplying electrical power to the electrical current,
a real time clock connected to the microcontroller:

16. A Nursing Monitor according to claim 15 wherein the electrical circuit is adapted to store and to display on the display screen the number of times that nursing occurs per-day and whether on the left breast or the right breast and the time breast feeding ceases and the duration of breast feeding for up to fourteen sessions per day for a total of up to seven days.

17. A Nursing Monitor according to claim 15 wherein the electrical circuit is adapted to store and to display on the display screen the number of times that nursing occurs per day and whether on the left breast or the right breast and the time breast feeding ceases and the duration of breast feeding for up to fourteen sessions per day for a total of up to seven days and to store the average duration of each nursing session for each day and the prior seven days.

18. A Nursing Monitor according to claim 15 wherein the electrical circuit is mounted on the center panel.

19. A Nursing Monitor according to claim 15 wherein a desk stand is mounted on the back panel.

20. A Nursing Monitor according to claim 15 wherein the three push buttons include a left push button, a center push button and a right push button, the left push button being for indicating the left breast and yes and down, the center push button being for opening a menu and activating a enter and the right push button being for indicating the right breast and no and up.
